(19) United States
(12) Patent Application Publication
(10) Pub. No.: US 2016/0113291 A1
(43) Pub. Date: Apr. 28, 2016

(54) Bun machine

(71) Applicant: AURNISH ENTERPRISES CORP., New York, NY (US)

(72) Inventor: PEI ZHONG HUANG, BRAMPTON (CA)

(73) Assignee: AURNISH ENTERPRISES CORP.

(21) Appl. No.: 14/523,949

(22) Filed: Oct. 27, 2014

(51) Int. Cl. A21C 3/02; A21C 15/00; A21D 13/00

(52) U.S. Cl. CPC A21C 3/02; A21D 13/0058; A21C 15/007

(57) ABSTRACT

A bun machine includes: a pressing device for forming a first layer and a second layer; an overlaying device for forming a bun crust with the first layer and the second layer; a main transporter, wherein a first end of the main transporter is connected to the overlaying device for transporting the bun crust; a feeding device provided aside the main transporter, comprising: a filling tank for storing and inputting fillings into the feeding device; and a feeding unit feeding the fillings onto the bun crust; a wrapping device provided above the main transporter, wherein the wrapping device wraps the fillings with the bun crust for forming a filled roll; and a separating device connected to a second end of the main transporter, wherein the separating device squeezes the filled roll for separating and sealing the filled roll, so as to produce buns.

### BACKGROUND OF THE PRESENT INVENTION

1. Field of Invention

The present invention relates to a technical field of food processing, and more particularly to a bun machine.

2. Description of Related Arts

The conventional bun machine is only able to filling a single layer of fermented dough with fillings for producing a bun. The bun may be fried or steamed. However, disadvantages of the bun produced by the conventional bun machine are as follows. Firstly, the fermented dough is soft. As a result, during producing or cooking, the bun is likely to be broken, which lowers quality and appearance of the bun. Secondly, the fermented dough has a lot of holes which absorb juice of the fillings. Therefore, taste of the bun is badly affected.

### SUMMARY OF THE PRESENT INVENTION

An object of the present invention is to provide a bun machine for producing a bun with a fermented dough outer layer and an unfermented dough inner layer.

Another object of the present invention is to provide a bun machine for producing a bun which is not easy to be broken and is able to keep juice of fillings inside the bun for a long time.

Accordingly, in order to accomplish the above objects, the present invention provides a bun machine, comprising:
a pressing device, comprising: a first tank for storing and inputting a fermented dough into the pressing device; a second tank for storing and inputting an unfermented dough into the pressing device; a first presser pressing the fermented dough inputted through the first tank for forming a first layer; a second presser pressing the unfermented dough inputted through the second tank for forming a second layer; a first outlet for outputting the first layer; and a second outlet for outputting the inner layer;
an overlaying device, comprising: a first transporter for transporting the first layer outputted from the first outlet; and a second transporter for transporting the second layer outputted from the second outlet; wherein a first end of the first transporter is connected to the first outlet, a first end of the second transporter is connected to the second outlet; a first transporting speed of the first transporter equals to a second transporting speed of the second transporter, and a second end of the second transporter is above the first transporter, in such a manner that the second layer drops to and overlays the first layer for forming a bun crust; a second end of the first transporter outputs the bun crust;
a main transporter, wherein a first end of the main transporter is connected to the overlaying device for transporting the bun crust;
a feeding device provided aside the main transporter, comprising: a filling tank for storing and inputting fillings into the feeding device; and a feeding unit feeding the fillings onto the bun crust;
a wrapping device provided above the main transporter, wherein the wrapping device wraps the fillings with the bun crust for forming a filled roll; said wrapping device forms an opening with said main transporter, in such a manner that said filled roller is still transported by said main transporter; and
a separating device connected to a second end of the main transporter, wherein the separating device squeezes the filled roll for separating and sealing the filled roll, so as to produce buns.

With the foregoing structure, the bun machine is able to produce a bun with two dough layers. An inner layer of the bun is made of the unfermented dough, and an outer layer of the bun is made of the fermented dough. Therefore, compared with a bun produced by a conventional bun machine, the bun produced by the bun machine according to the present invention is not easy to be broken and is able to keep juice of fillings inside the bun for a long time.

These and other objectives, features, and advantages of the present invention will become apparent from the following detailed description, the accompanying drawings, and the appended claims.

### BRIEF DESCRIPTION OF THE DRAWINGS

FIG. 1 is a front view of a bun machine according to a preferred embodiment of the present invention.

FIG. 2 is a structural view of a pressing device according to the preferred embodiment of the present invention.

FIG. 3 is a perspective view of a wrapping device according to the preferred embodiment of the present invention.

FIG. 4 is a structural view of a separating device according to the preferred embodiment of the present invention.

FIG. 5 is a perspective view of a first transporter according to the preferred embodiment of the present invention.

FIG. 6 is a perspective view of a second transporter according to the preferred embodiment of the present invention.

FIG. 7 is a perspective view of a main transporter according to the preferred embodiment of the present invention.

FIG. 8 is a perspective view of a bun transporter according to the preferred embodiment of the present invention.

### DETAILED DESCRIPTION OF THE PREFERRED EMBODIMENT

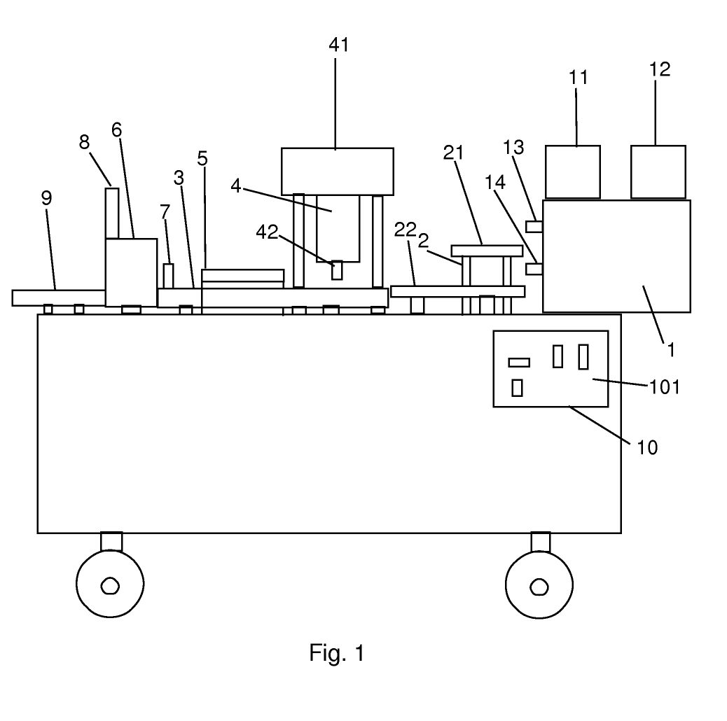

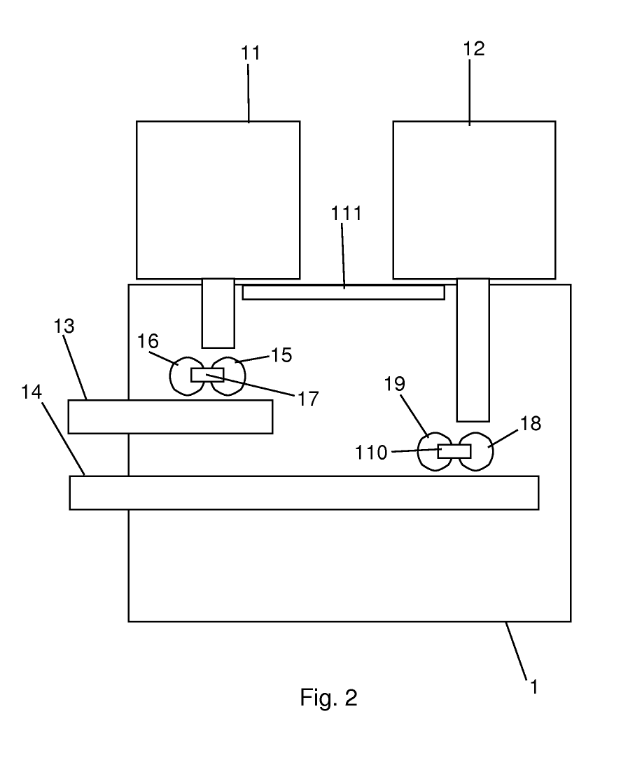

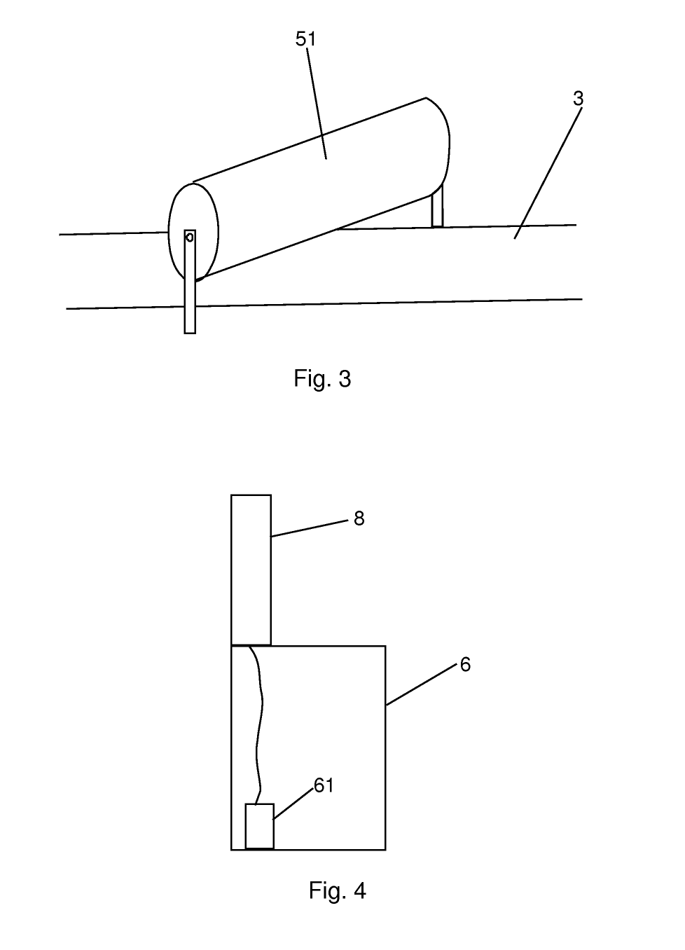

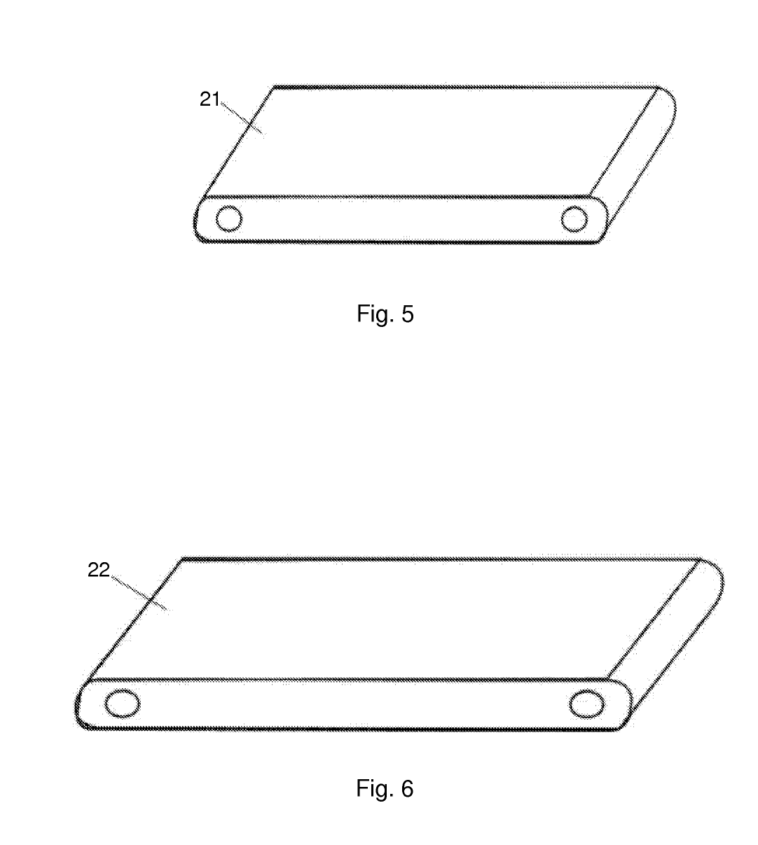

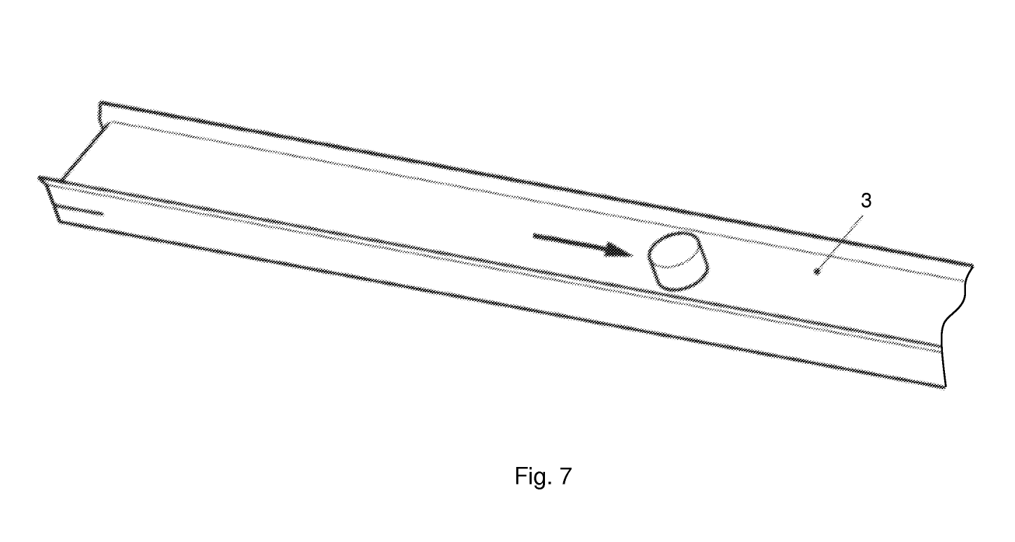

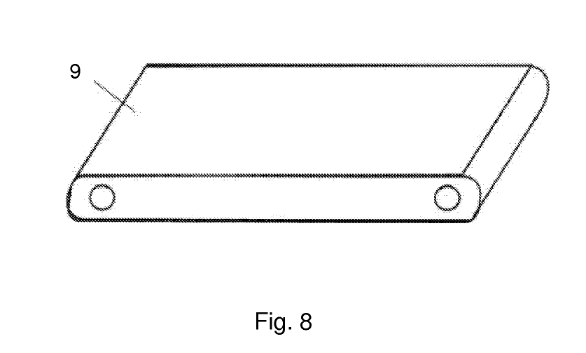

Referring to FIGS. 1˜8 of the drawings, a bun machine according to a preferred embodiment of the present invention is illustrated, comprising:
a pressing device 1, comprising: a first tank 12 for storing and inputting a fermented dough into the pressing device 1; a second tank 11 for storing and inputting an unfermented dough into the pressing device 1; a first presser pressing the fermented dough inputted through the first tank 12 for forming a first layer; a second presser pressing the unfermented dough inputted through the second tank 11 for forming a second layer; a first outlet 14 for outputting the first layer; and a second outlet 13 for outputting the second layer;
an overlaying device 2, comprising: a first transporter 22 for transporting the first layer outputted from the first outlet 14; and a second transporter 21 for transporting the second layer outputted from the second outlet 13; wherein a first end of the first transporter 22 is connected to the first outlet 14, a first end of the second transporter 21 is connected to the second outlet 13; a first transporting speed of the first transporter 22 equals to a second transporting speed of the second transporter 21, and a second end of the second transporter 21 is above the first transporter 22, in such a manner that the second layer drops to and overlays the first layer for forming a bun crust; a second end of the first transporter 22 outputs the bun crust;
a main transporter 3, wherein a first end of the main transporter 3 is connected to the overlaying device 2 for transporting the bun crust;
a feeding device 4 provided aside the main transporter 3, comprising: a filling tank 41 for storing and inputting fillings into the feeding device 4; and a feeding unit 42 feeding the fillings onto the bun crust;
a wrapping device 5 provided above the main transporter 3, wherein the wrapping device 5 wraps the fillings with the bun crust for forming a filled roll; said wrapping device forms an opening with said main transporter, in such a manner that said filled roller is still transported by said main transporter; and
a separating device 6 connected to a second end of the main transporter 3, wherein the separating device 6 squeezes the filled roll for separating and sealing the filled roll, so as to produce buns.

With the foregoing structure, the bun machine is able to produce a bun with two dough layers. An inner layer of the bun is made of the unfermented dough, and an outer layer of the bun is made of the fermented dough. Therefore, compared with a bun produced by a conventional bun machine, the bun produced by the bun machine according to the present invention is not easy to be broken and is able to keep juice of fillings inside the bun for a long time.

Preferably, the first presser comprises a first roller 15 and a second roller 16, wherein the fermented dough passes between the first roller 15 and the second roller 16 for being pressed; a first thickness of the first layer is adjustably by changing a distance between the first roller 15 and the second roller 16; a first width limiter 17 is mounted at two sides of the first presser for limiting a first width of the first layer, the first width is adjustable by adjusting the first width limiter 17; wherein the second presser comprises a third roller 18 and a fourth roller 19, wherein the unfermented dough passes between the third roller 18 and the fourth roller 19 for being pressed; a second thickness of the second layer is adjustably by changing a distance between the third roller 18 and the fourth roller 19; a second width limiter 110 is mounted at two sides of the first presser for limiting a second width of the first layer, the second width is adjustable by adjusting the second width limiter 110.

Preferably, the pressing device 1 further comprises a powdering device 111, wherein the powdering device 111 sprays flour to the first layer and the second layer for preventing the first layer and the second layer from sticking on the pressing device 1.

Preferably, a feeding speed of the feeding device 4 is adjustable by changing an opening size of the feeding unit 42.

Preferably, the wrapping device 5 comprises a wrapping roller 51, a distance between the wrapping roller 51 and the main transporter 3 is less than a thickness of the bun crust, in such a manner that said wrapping roller 51 contacts with said bun crust; the wrapping roller 51 is diagonally placed above the main transporter 3 with a first end of the wrapping roller 51 close to the feeding device 4 and a second end of the wrapping roller 51 close to the separating device 6, and rolls with a pre-determined direction and a pre-determined speed, in such a manner that the bun crust is rolled with a pre-determined internal diameter and the fillings are wrapped by the bun crust for forming the filled roll, wherein said pre-determined internal diameter is larger than a width of the fillings on said bun crust, in such a manner that the fillings are wrapped with said bun crust around; or said pre-determined internal diameter is smaller than said width of said fillings on said bun crust, in such a manner that the fillings are rolled with said bun crust before being completely wrapped.

Preferably, the bun machine further comprises a guiding device 7 mounted the wrapping device 5 and the separating device 6, for guiding the filled roller into the separating device 6.

Preferably, the separating device 6 comprises a patterning unit 61 for carving a pattern on the bun.

Preferably, the bun machine further comprises an oil dropper 8 mounted on the separating device 6 for preventing the bun from sticking on the separating device 6.

Preferably, the bun machine further comprises a bun transporter 9 connected to the separating device 6 for outputting the bun.

Preferably, the bun machine further comprises a control system 10 connected to the pressing device 1, the overlaying device 2, the main transporter 3, the feeding device 4, the wrapping device 5 and the separating device 6, wherein the control system 10 comprises:
a control panel 101 for selecting orders comprising turning on/off the bun machine, adjusting pressing device 1, adjusting the overlaying device 2, adjusting the main transporter 3, adjusting the feeding device 4, adjusting the wrapping device 5 and adjusting the separating device 6; and
a control module controlling the bun machine according to the orders selected through the control panel 101.

With the foregoing structure, by operating the control panel 101, the first thickness and the first width of the first layer, the second thickness and the second width of the second layer, the feeding speed of the feeding device 4, and a transporting speed of the main transporter 3 are adjustable. As a result, a weight range of the bun produced is 30˜150 g, and a producing speed is 10˜100 buns per minute.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A bun machine, comprising:
a pressing device, comprising: a first tank for storing and inputting a fermented dough into said pressing device; a second tank for storing and inputting an unfermented dough into said pressing device; a first presser pressing the fermented dough inputted through said first tank for forming a first layer; a second presser pressing the unfermented dough inputted through said second tank for forming a second layer; a first outlet for outputting said first layer; and a second outlet for outputting said second layer;
an overlaying device, comprising: a first transporter for transporting said first layer outputted from said first outlet; and a second transporter for transporting said second layer outputted from said second outlet; wherein a first end of said first transporter is connected to said first outlet, a first end of said second transporter is connected to said second outlet; a first transporting speed of said first transporter equals to a second transporting speed of said second transporter, and a second end of said second transporter is above said first transporter, in such a manner that said second layer drops to and overlays said first layer for forming a bun crust; a second end of said first transporter outputs said bun crust;
a main transporter, wherein a first end of said main transporter is connected to said overlaying device for transporting said bun crust;
a feeding device provided aside said main transporter, comprising: a filling tank for storing and inputting fillings into said feeding device; and a feeding unit feeding the fillings onto said bun crust;
a wrapping device provided above said main transporter, wherein said wrapping device wraps the fillings with said bun crust for forming a filled roll; said wrapping device forms an opening with said main transporter, in such a manner that said filled roller is still transported by said main transporter; and
a separating device connected to a second end of said main transporter, wherein said separating device squeezes said filled roll for separating and sealing said filled roll, so as to produce buns.

2. The bun machine, as recited in claim 1, wherein said first presser comprises a first roller and a second roller, wherein the fermented dough passes between said first roller and said second roller for being pressed; a first thickness of said first layer is adjustably by changing a distance between said first roller and said second roller; a first width limiter is mounted at two sides of said first presser for limiting a first width of said first layer, said first width is adjustable by adjusting said first width limiter; wherein said second presser comprises a third roller and a fourth roller, wherein the unfermented dough passes between said third roller and said fourth roller for being pressed; a second thickness of said second layer is adjustably by changing a distance between said third roller and said fourth roller; a second width limiter is mounted at two sides of said first presser for limiting a second width of said first layer, said second width is adjustable by adjusting said second width limiter.

3. The bun machine, as recited in claim 1, wherein said pressing device further comprises a powdering device, wherein said powdering device sprays flour to said first layer and said second layer for preventing said first layer and said second layer from sticking on said pressing device.

4. The bun machine, as recited in claim 2, wherein said pressing device further comprises a powdering device, wherein said powdering device sprays flour to said first layer and said second layer for preventing said first layer and said second layer from sticking on said pressing device.

5. The bun machine, as recited in claim 1, wherein a feeding speed of said feeding device is adjustable by changing an opening size of said feeding unit.

6. The bun machine, as recited in claim 4, wherein a feeding speed of said feeding device is adjustable by changing an opening size of said feeding unit.

7. The bun machine, as recited in claim 1, wherein said wrapping device comprises a wrapping roller, a distance between said wrapping roller and said main transporter is less than a thickness of said bun crust, in such a manner that said wrapping roller contacts with said bun crust; said wrapping roller is diagonally placed above said main transporter with a first end of said wrapping roller close to said feeding device and a second end of said wrapping roller close to said separating device, and rolls with a pre-determined direction and a pre-determined speed, in such a manner that said bun crust is rolled with a pre-determined internal diameter and the fillings are wrapped by said bun crust for forming said filled roll, wherein said pre-determined internal diameter is larger than a width of the fillings on said bun crust, in such a manner that the fillings are wrapped with said bun crust around; or said pre-determined internal diameter is smaller than said width of said fillings on said bun crust, in such a manner that the fillings are rolled with said bun crust before being completely wrapped.

8. The bun machine, as recited in claim 6, wherein said wrapping device comprises a wrapping roller, a distance between said wrapping roller and said main transporter is less than a thickness of said bun crust, in such a manner that said wrapping roller contacts with said bun crust; said wrapping roller is diagonally placed above said main transporter with a first end of said wrapping roller close to said feeding device and a second end of said wrapping roller close to said separating device, and rolls with a pre-determined direction and a pre-determined speed, in such a manner that said bun crust is rolled with a pre-determined internal diameter and the fillings are wrapped by said bun crust for forming said filled roll, wherein said pre-determined internal diameter is larger than a width of the fillings on said bun crust, in such a manner that the fillings are wrapped with said bun crust around; or said pre-determined internal diameter is smaller than said width of said fillings on said bun crust, in such a manner that the fillings are rolled with said bun crust before being completely wrapped.

9. The bun machine, as recited in claim 1, further comprising a guiding device mounted said wrapping device and said separating device, for guiding said filled roller into said separating device.

10. The bun machine, as recited in claim 8, further comprising a guiding device mounted said wrapping device and said separating device, for guiding said filled roller into said separating device.

11. The bun machine, as recited in claim 1, wherein said separating device comprises a patterning unit for carving a pattern on said bun.

12. The bun machine, as recited in claim 10, wherein said separating device comprises a patterning unit for carving a pattern on said bun.

13. The bun machine, as recited in claim 1, further comprising an oil dropper mounted on said separating device for preventing said bun from sticking on said separating device.

14. The bun machine, as recited in claim 12, further comprising an oil dropper mounted on said separating device for preventing said bun from sticking on said separating device.

15. The bun machine, as recited in claim 1, further comprising a bun transporter connected to said separating device for outputting said bun.

16. The bun machine, as recited in claim 14, further comprising a bun transporter connected to said separating device for outputting said bun.

17. The bun machine, as recited in claim 1, further comprising a control system connected to said pressing device, said overlaying device, said main transporter, said feeding device, said wrapping device and said separating device, wherein said control system comprises:
a control panel for selecting orders comprising turning on/off said bun machine, adjusting pressing device, adjusting said overlaying device, adjusting said main transporter, adjusting said feeding device, adjusting said wrapping device and adjusting said separating device; and
a control module controlling said bun machine according to said orders selected through said control panel.

18. The bun machine, as recited in claim 16, further comprising a control system connected to said pressing device, said overlaying device, said main transporter, said feeding device, said wrapping device and said separating device, wherein said control system comprises:
a control panel for selecting orders comprising turning on/off said bun machine, adjusting pressing device, adjusting said overlaying device, adjusting said main transporter, adjusting said feeding device, adjusting said wrapping device and adjusting said separating device; and
a control module controlling said bun machine according to said orders selected through said control panel.

19. A bun, produced by the bun machine as recited in claim 1.
